(19) United States
(12) Patent Application Publication
(10) Pub. No.: US 2006/0030649 A1
(43) Pub. Date: Feb. 9, 2006

(54) Acrylic resin composition

(75) Inventors: Ryu Takeko, Ashiya-shi (JP); Akira Kawamura, Osaka (JP)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 11/197,648

(22) Filed: Aug. 5, 2005

(30) Foreign Application Priority Data
Aug. 9, 2004 (JP) 2004-231987

(51) Int. Cl. C07F 7/10; C08L 31/02

(52) U.S. Cl. 524/188

(57) ABSTRACT

An acrylic resin composition comprising an acrylic resin and a silane-based compound having an azole group and having at least one group selected from the group consisting of a phenoxy group and an alkoxy group.

### BACKGROUND OF THE INVENTION

1. Technical Field of the Invention

The present invention relates to an acrylic resin composition.

2. Description of the Related Art

Liquid crystal cells generally used in liquid crystal displays such as a TN liquid crystal cell (TFT), a STN liquid crystal cell (STN) and the like, have a structure in which a liquid crystal component is sandwiched between two glass base materials. On the surface of the glass base material an optical film such as a polarizing film, phase retardation film and the like is laminated via an adhesive composed mainly of an acrylic resin. An optical laminate composed of a glass base material, adhesive and optical film laminated in this order is in general produced by a method in which first an optical laminated film having an adhesive layer composed of an adhesive laminated on an optical film is obtained, and then, a glass base material is laminated on the surface of the adhesive layer.

Such an optical laminated film tends to generate curl and the like due to large dimension change by expansion and shrinkage under heating or moistening and heating conditions, consequently, there are problems such as occurrence of foaming in an adhesive layer of the resulted optical laminate, generation of peeling between an adhesive layer and a glass base material, and the like. Under heating or moistening and heating conditions, distribution of remaining stress acting on an optical laminated film becomes non-uniform, concentration of stress occurs around peripheral parts of an optical laminate, consequently, there is a problem that light leakage occurs in a TN liquid crystal cell (TFT).

Further, recently, such a liquid display is used for vehicle-mounted applications such as a car navigation system and the like, however, in vehicle-mounted applications, durability such as no occurrence of appearance change such as foaming, floating, peeling, fogging and the like is also being required.

For solving such a problem, there is suggested an adhesive prepared by compounding a silane compound containing a hydrocarbon group and an alkoxy group into an adhesive mainly composed of an acrylic resin (Japanese Patent No. 3498156 [claim 1, Examples 1 to 4]).

However, an optical laminate obtained by laminating a glass base material on an optical laminated film composed of an optical film and an adhesive containing diphenyldimethoxysilane was subjected to 100 cycles of 60° C.→−20° C.→60° C. procedure, consequently, fogging occurred on the surface of the glass base material, revealing insufficient durability.

### DISCLOSURE OF THE INVENTION

An object of the present invention is to provide an acrylic resin composition capable of producing an optical laminate in which light leakage is suppressed, floating and peeling between a glass base material and an adhesive layer in an optical laminate and foaming in an adhesive layer can be suppressed, further, even if heating and cooling are repeated, durability such as no occurrence of appearance changes such as light leakage, floating, peeling, foaming, fogging and the like.

Namely, the present invention provides the following [1] to [12].

[1] An acrylic resin composition comprising an acrylic resin and a silane-based compound having an azole group and having at least one group selected from the group consisting of a phenoxy group and alkoxy group.

[2] The composition according to [1], wherein the silane-based compound is a compound of the formula (3), a compound of the formula (4), a compound of the formula (6), or a compound of the formula (7): 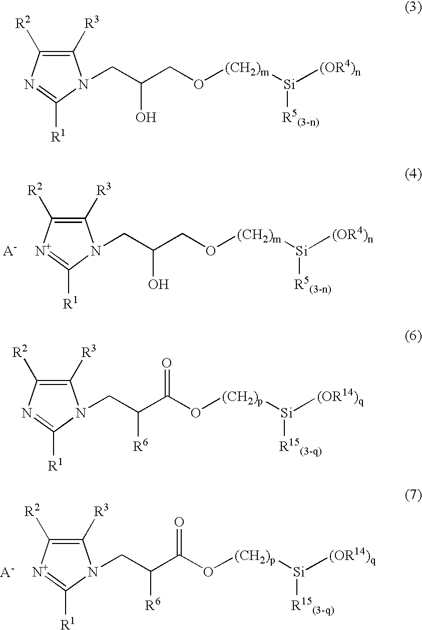
(wherein, R¹ to R³ represent each independently a hydrogen atom or a hydrocarbon group having 1 to 20 carbon atoms wherein the hydrocarbon group may contain a double bond, and R² and R³ may be connected, R⁴, R⁵, R⁶, R¹⁴ and R¹⁵ represent each independently a hydrogen atom, an aliphatic hydrocarbon group having 1 to 12 carbon atoms or an aromatic hydrocarbon group having 6 to 12 carbon atoms, m represents 1 to 10, n represents 1 to 3, p represents the same meanings as m, q represents the same meanings as n, and A⁻ represents an organic monocarboxylic acid residue).

[3] The composition according to [1] or [2], wherein the silane-based compound is a compound selected from the group consisting of a compound of the formula (3-1), a compound of the formula (4-1), a compound of the formula (6-1) and a compound of the formula (7-1): 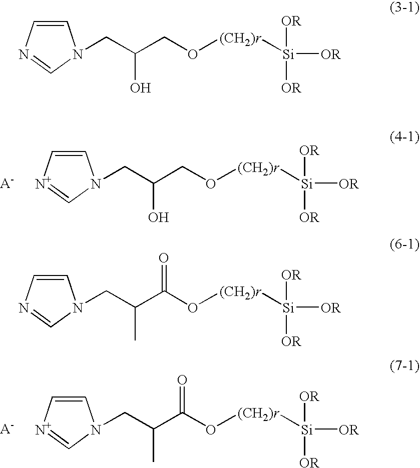
(wherein, R represents a methyl group or ethyl group, r represents 2 or 3, and A⁻ have the same meanings as defined above).

[4] The composition according to any of [1] to [3] wherein the acrylic resin is an acrylic resin having a structural unit derived from an alkyl (meth)acrylate as a main component, and containing a structural unit derived from (meth)acrylic acids containing at least one polar functional group selected from the group consisting of a hydroxyl group, amino group, free carboxyl group and heterocyclic group.

[5] An adhesive obtained by compounding the composition according to any of [1] to [4], and a cross-linking agent.

[6] An optical laminated film laminating an adhesive layer composed of the adhesive according to [5] on both surfaces or one surface of an optical film.

[7] The optical laminated film according to [6], wherein the optical film is a polarizing film and/or phase retardation film.

[8] The optical laminated film according to [6] or [7], wherein the optical film further has an acetylcellulose-based film as a release film.

[9] The optical laminated film according to any one of [6] to [8], wherein a release film is further laminated on the adhesive layer of the optical laminated film.

[10] An optical laminate obtained by laminating a glass base material on the adhesive layer of the optical laminated film according to any one of [6] to [8].

[11] An optical laminate obtained by peeling the release film from the optical laminated film according to [9], then, laminating a glass base material on the adhesive layer of the optical laminated film.

[12] An optical laminate obtained by peeling the optical laminated film from the optical laminate according to [10] or [11], then, laminating again the optical laminated film on the resulted glass base material.

The present invention will be described in detail below.

The acrylic resin composition of the present invention contains an acrylic resin and a silane-based compound.

The silane-based compound used in the present invention is a silane-based compound containing an azole group and containing a phenoxy group and/or alkoxy group (hereinafter, referred to as silane compound in some cases). Preferably, it is a silane-based compound containing an azole group composed of nitrogen, carbon and hydrogen, and an alkoxy group, more preferably, it is a silane-based compound containing an imidazole group and alkoxy group.

The phenoxy group and/or alkoxy group is usually bonded to a silicon atom, and the phenoxy group and alkoxy group may be substituted by a halogen atom or an alkyl group having approximately 1 to 2 carbon atoms, however, it is preferable that they are not substituted.

Regarding a method of producing a silane compound wherein the azole group is an imidazole group, there are exemplified a method in which an imidazole compound of the formula (1) and a compound of the formula (2) are reacted at 80 to 200° C. to obtain a product containing a compound of the formula (3) as a main component, a method in which an organic monocarboxylic acid (AH) is further reacted with the above-mentioned product at 50 to 200° C. to obtain a product containing a compound of the formula (4) as a main component, and the like.

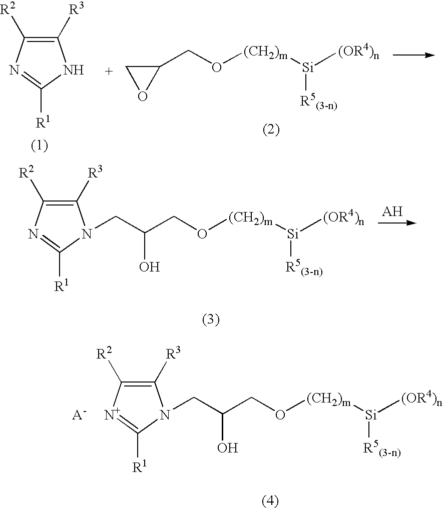

In the formulae, R⁴ to R⁵ represent each independently a hydrogen atom, an aliphatic hydrocarbon group having approximately 1 to 12 carbon atoms such as a methyl group, ethyl group, n-propyl group, i-propyl group, t-butyl group, 2-ethylhexyl group and the like, or an aromatic hydrocarbon group having approximately 6 to 12 carbon atoms such as a phenyl group, benzyl group, and the like.

R¹ to R³ represent each independently a hydrogen atom, vinyl group, a hydrocarbon group having approximately 1 to 20 carbon atoms such as an aliphatic hydrocarbon group as defined above, an aromatic hydrocarbon group as defined above, and the like. R² and R³ may be connected, for example, may form an aromatic ring with an imidazole group in the formula.

m represents approximately 1 to 10, preferably 2 to 5, n represents 1 to 3, preferably 2 to 3, and A⁻ represents an organic monocarboxylic acid residue.

Examples of the organic monocarboxylic acid include an aliphatic saturated monocarboxylic acid such as isobutyric acid, octylic acid, formic acid, glyoxylic acid, crotonic acid, acetic acid, propionic acid, and the like;
an aliphatic unsaturated monocarboxylic acid such as acrylic acid, methacrylic acid, and the like:
an aromatic monocarboxylic acid such as benzolc acid, salicylic acid, toluic acid, phenyl acetic acid, p-t-butyl benzoic acid, and the like;
an alicyclic monocarboxylic acid such as cyclohexane carboxylic acid, and the like.

Among them, aliphatic unsaturated monocarboxylic acids are preferably used.

Examples of the imidazole compound of the formula (1) include imidazole; 2-alkylimidazoles such as 2-methylimidazole, 2-ethylimidzole, 2-undecylimidazole and the like; 2,4-dialkylimidazole; 4-vinylimidazole and the like, and of them, imidazole and 2-alkylimidazoles are preferable, and imidazole is more preferable.

Examples of the silane compound having a glycidoxyl group of the formula (2) include 3-glycidoxypropyltrialkoxysilanes such as 3-glycidoxypropyltrimethoxysilane, 3-glycidoxypropyltriethoxysilane and the like; 3-glycidoxypropyldialkoxyalkylsilanes such as 3-glycidoxypropyldimethoxymethylsilane and the like; 3-glycidoxypropylalkoxydialkylsilens such as 3-glycidoxypropylethoxydimethylsilane and the like; and the like. Of them, 3-glycidoxypropyltrialkoxysilanes are preferable.

Regarding a method of producing a silane compound wherein the azole group is an imidazole group, there are exemplified another method in which an imidazole compound of the formula (1) and a compound of the formula (5) are reacted at 80 to 200° C. to obtain a product containing a compound of the formula (6) as a main component, a method in which an organic monocarboxylic acid (AH) is further reacted with the above-mentioned product at 50 to 200° C. to obtain a product containing a compound of the formula (7) as a main component, and the like.

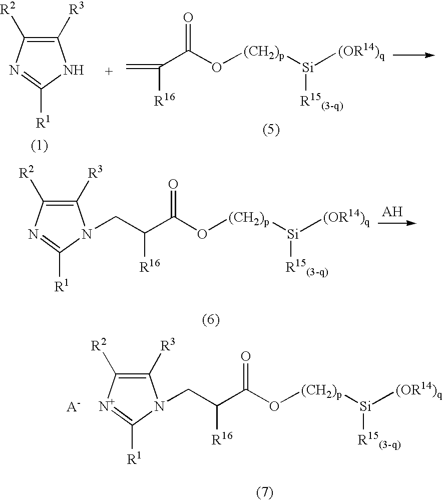

In the formula, R⁶ represents a hydrogen atom, an aliphatic hydrocarbon group having approximately 1 to 12 carbon atoms such as a methyl group, ethyl group, and the like, an aromatic hydrocarbon group such as a phenyl group, benzyl group, and the like. Among them, a hydrogen atom and a methyl group are preferable.

R¹¹ to R¹³ each independently represent the same meanings as R¹, R¹⁴ to R¹⁶ each independently represent the same meanings as R⁴.

p represents the same meanings as m, q represents the same meanings as n.

Examples of a silane-based compound having a (meth)acryloyl group of formula (5) include 3-methacryloyloxy propyl dialkoxy silane such as 3-methacryloyloxy propyl dimethoxy silane, 3-methacryloyloxy propyl diethoxy silane;
3-methacryloyloxy propyl trialkoxy silane such as 3-methacryloyloxypropyl trimethoxy silane, 3-methacryloyloxy propyl triethoxy silane;
3-acryloyloxy propyl dialkoxy silane such as 3-acryloyloxy propyl dimethoxy silane;
3-acryloyloxy propyl trialkoxy silans such as 3-acryloyloxy propyl trimethoxy silane, and the like.

Particularly, 3-methacryloyloxy propyl trialkoxy silanes are preferably used.

As the silane-based compound containing an azole group and containing a phenoxy group and/or alkoxy group, compounds of the formula (3-1), compounds of the formula (4-1), compounds of the formula (6-1), and compounds of the formula (7-1) are preferable since they are available easily.

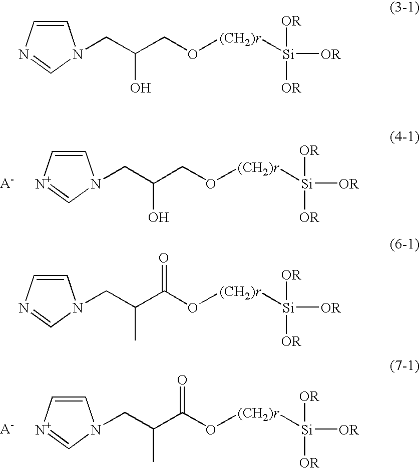

In the formula, R represents a methyl group or ethyl group, r represents 2 or 3, A⁻ represents the same meanings as defined above.

As the silane-based compound containing an azole group and alkoxy group, commercially available products may be used, and for example, IM series of Nikko Materials and the like may be used as they are.

The use amount (non-volatile content) of a silane-based compound in the composition of the present invention is usually approximately 0.0001 to 10 parts by weight, preferably 0.01 to 5 parts by weight based on 100 parts by weight (non-volatile content) of an acrylic resin. When the amount of a silane-based compound is 0.0001 part by weight or more, close adherence between an adhesive layer and a glass base plate is improved preferably. When the amount of a silane-based compound is 10 parts by weight or less, breeding out of a silane-based compound from an adhesive layer tends to be suppressed.

The acrylic resin used in the present invention is usually an acrylic resin having a structural unit derived from an alkyl (meth)acrylate as a main component, and containing a structural unit derived from (meth)acrylic acids containing a polar functional group such as a hydroxyl group, amino group, free carboxyl group, heterocyclic group and the like (hereinafter, referred to as polar functional group-containing monomer in some cases).

The (meth)acrylate used here includes alkyl acrylates such as methyl acrylate, ethyl acrylate, propyl acrylate, n-butyl acrylate, iso-butyl acrylate, 2-ethylhexyl acrylate, n-octyl acrylate, iso-octyl acrylate, lauryl acrylate, stearyl acrylate, cyclohexyl acrylate, isobornyl acrylate, benzyl acrylate, methoxyethyl acrylate, ethoxymethyl acrylate and the like; alkyl methacrylates such as methyl methacrylate, ethyl methacrylate, propyl methacrylate, n-butyl methacrylate, isobutyl methacrylate, 2-ethylhexyl methacrylate, n-octyl methacrylate, iso-octyl methacrylate, lauryl methacrylate, stearyl methacrylate, cyclohexyl methacrylate, isobornyl methacrylate, benzyl methacrylate, methoxyethyl methacrylate, ethoxymethyl methacrylate and the like.

As the alkyl (meth)acrylate, a plurality of different alkyl (meth)acrylates may be used. The acrylic resin used in the present invention contains a structural unit derived from an alkyl (meth)acrylate in an amount of usually 60 to 99.9 parts by weight, preferably 80 to 99.6 parts by weight based on 100 parts by weight (non-volatile content) of the resin.

Examples of the polar functional group-containing monomer include monomers containing a free carboxyl group such as acrylic acid, methacrylic acid, β-carboxyethyl acrylate and the like;
hydroxyl group-containing monomers such as 2-hydroxyethyl (meth)acrylate, 2-hydroxypropyl (meth)acrylate, chloro-2-hydroxypropyl (meth)acrylate, diethylene glycol mono(meth)acrylate and the like;
monomers having a heterocyclic group such as acryloylmorpholine, vinylcaprolactam, N-vinyl-2-pyrrolidone, tetrahydrofurfuryl acrylate, tetrahydrofurfuryl methacrylate, caprolactone-modified tetrahydrofurfuryl acrylate, 3,4-epoxycyclohexylmethyl acrylate, 3,4-epoxycyclohexylmethyl methacrylate, glycidyl (meth)acrylate, 2,5-dihydrofurane and the like;
monomers containing an amino group different from a heterocycle such as dimethylaminoethyl (meth)acrylate, and the like.

As the polar functional group-containing monomer, a plurality of different polar functional group-containing monomers may be used. The acrylic resin used in the present invention contains a structural unit derived from a polar functional group-containing monomer in an amount of usually 0.1 to 20 parts by weight, preferably 0.4 to 10 parts by weight based on 100 parts by weight of the resin.

The acrylic resin used in the present invention may have structural units derived from an alkyl (meth)acrylate and a monomer other than the polar functional group-containing monomer, and examples thereof include structural units derived from styrene-based monomers, structural units derived from vinyl-based monomers, and structural units derived from monomers having a plurality of (meth)acryloyl groups in the molecule.

Specific examples of the styrene-based monomer include styrene and alkylstyrenes such as methylstyrene, dimethylstyrene, trimethylstyrene, ethylstyrene, diethylstyrene, triethylstyrene, propylstyrene, butylstyrene, hexylstyrene, heptylstyrene, octylstyrene and the like; halogenated styrenes such as fluorostyrene, chlorostyrene, bromostyrene, dibromostyrene, iodostyrene and the like; nitrostyrene, acetylstyrene, methoxystyrene, divinylbenzene and the like.

Examples of the vinyl-based monomer include aliphatic acid vinyl esters such as vinyl acetate, vinyl propionate, vinyl butyrate, vinyl 2-ethylhexanoic acid, vinyl laurate and the like; halogenated vinyls such as vinyl chloride, vinyl bromide and the like; halogenated vinylidenes such as vinylidene chloride and the like; nitrogen-containing aromatic vinyls such as vinylpyridine, vinylpyrrolidone, vinylcarbazole and the like: conjugated diene monomers such as butadiene, isoprene, chloroprene and the like; divlnylbenzene; acrylonltrile; methacrylonitrile.

Examples of the monomer having a plurality of (meth)acryloyl groups in the molecule include monomers having two (meth)acryloyl groups in the molecule such as 1,4-butanediol di(meth)acrylate, 1,6-hexanediol (meth)diacrylate, 1,9-nonanediol di(meth)acrylate, ethylene glycol di(math)acrylate, diethylene glycol di(math)acrylate, tetraethylene glycol di(meth)acrylate, tripropylene glycol di(meth)acrylate and the like; monomers having three (meth)acryloyl groups in the molecule such as trimethylolpropane tri(meth)acrylate and the like.

These monomers may be used singly or in combination. In the acrylic resin used in the present invention, the content of structural units derived from an alkyl (meth)aorylate and a monomer other than the polar functional group-containing monomer is usually 0 to 20 parts by weight, preferably 0 to 10 parts by weight based on 100 parts by weight of the resin.

As the method of producing the acrylic resin used in the present invention, for example, a solution polymerization method, emulsion polymerization method, block polymerization method, suspension polymerization method and the like are listed. In production of an acrylic resin, a polymerization initiator is usually used. The polymerization initiator is usually used in an amount of approximately 0.001 to 5 parts by weight based on 100 parts by weight of all monomers used In production of an acrylic resin.

As the polymerization initiator, for example, a heat-polymerization initiator, photo-polymerization initiator, and the like are listed.

Examples of the heat-polymerization initiator include azo-based compounds such as 2,2′-azobisisobutyronitrile, 2,2′-azobis(2-methylbutyronitrile), 1,1′-azobis(cyclohexane-1-carbonitrlle), 2,2′-azobis(2,4-dimethylvaleronitrile), 2,2′-azobis(2,4-dimethyl-4-methoxyvaletonitrile), dimethyl-2,2′-azobis(2-methyl propionate), 2,2′-azobts(2-hydroxymethylpropionitrile) and the like; organic peroxides such as lauryl peroxide, tert-butyl hydroperoxide, benzoyl peroxide, tert-butyl peroxybenzoate, cumene hydroperoxide, diisopropyl peroxy dicarbonate, di-n-propyl peroxydicarbonate, tert-butyl peroxyneodecanoate, tert-butyl peroxypivalate, (3,5,5-trimethylhexanonyl) peroxide and the like;

inorganic peroxides such as potassium persulfate, ammonium persulfate, hydrogen peroxide and the like.

Examples of the photo-polymerization initiator include 4-(2-hydroxyethoxy)phenyl(2-hydroxy-2-propyl)ketone and the like.

Redox-based initiators using a heat-polymerization initiator and a reducing agent together can also be used as a polymerization initiator.

As the method of producing an acrylic resin, a solution polymerization method is preferable.

Specifically mentioned as the solution polymerization method are a method in which given monomers and an organic solvent are mixed, a heat-polymerization initiator is added under a nitrogen atmosphere, and the mixture is stirred for approximately 3 to 10 hours at approximately 40 to 90° C., preferably approximately 60 to 80° C., and other methods. For controlling the reaction, a method in which monomers and a heat-polymerization initiator used are added during polymerization, a method in which these are dissolved in an organic solvent before addition thereof, and the like may be adopted.

Here, examples of the organic solvent include aromatic hydrocarbons such as toluene, xylene and the like; esters such as ethyl acetate, butyl acetate and the like; aliphatic alcohols such as n-propyl alcohol, isopropyl alcohol and the like; ketones such as methyl ethyl ketone, methyl isobutyl ketone and the like.

The weight-average molecular weight based on polystyrene calibration standard of gel permeation chromatography (GPC) of the acrylic resin is usually 1×10⁴-150×10⁴. When the weight-average molecular weight is 1×10⁴ or more, adhesion under high temperature and high humidity increases, and floating and pealing between a glass base plate and an adhesive layer tends to lower, further, a re-working property tends to be improved, preferably. When the weight-average molecular weight is 150×10⁴ or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

The adhesive of the present invention can be obtained by compounding a cross-linking agent to the acrylic resin composition of the present invention.

Here, the cross-linking agent has in the molecule two or more functional groups capable of cross-linking with a polar functional group, and specific examples thereof include isocyanate-based compounds, epoxy-based compounds, metal chelate-based compounds, aziridine-based compounds and the like.

Here, examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isooyanate and the like, and adducts obtained by reacting polyols such as glycerol, trimethylolpropane and the like with the above-mentioned isocyanate compounds, and those obtained by converting the isocyanate compounds into dimmers, trimers and the like, are also included.

Examples of the epoxy-based compound include bisphenol A type epoxy resin, ethylene glycol glycidyl ether, polyethylene glycol diglycidyl ether, glycerine glycidyl ether, glycerine triglycidyl ether, 1,6-hexanediol diglycidyl ether, trimethylolpropane triglycidyl ether, diglycidylaniline, N,N,N,N′-tetraglycidyl-m-xylenediamine, 1,3-bis(N,N′-diglycidylaminomethyl)cyclohexane and the like.

Examples of the metal chelate compound include compounds obtained by coordinating acetylacetone or ethyl acetoacetate on poly-valent metals such as aluminum, iron, copper, zinc, tin, titanium, nickel, antimony, magnesium, vanadium, chromium, zirconium and the like.

Examples of the aziridine-based compound include N,N′-diphenylmethane-4,4′-bis(1-aziridine carboxide), N,N′-toluene-2,4-bis(1-aziridine carboxamide), triethylenemelamine, bisisophthaloyl-1-(2-methylaziridine), tri-1-azlridinylphosphine oxide, N,N′-hexamethylene-1,6-bis(1-aziridine carboxide), trimethylolpropane-tri-β-aziridinyl propionate, tetramethylolmethane-tri-β-aziridinyl propionate, and the like.

The cross-linking agent may be used alone or in combination of two or more. The use amount of a cross-linking agent (non-volatile component) in an adhesive is usually from approximately 0.005 to 5 parts by weight, preferably from approximately 0.01 to 3 parts by weight based on 100 parts by weight of an acrylic resin (non-volatile component). When the amount of the cross-linking agent is 0.005 parts by weight or more, floating and peeling between a glass base plate and an adhesive layer and a re-working property tend to be improved preferably, and when 5 parts by weight or less, a property of an adhesive layer to follow the dimension change of an optical film is excellent, consequently, light leakage and non-uniformity of color tend to lower preferably.

To the adhesive of the present invention, a cross-linking catalyst, a weather-resistant stabilizer, tackifier, plasticizer, softening agent, dye, pigment, inorganic filler and the like may be further compounded.

The optical laminated film can be produced in comparatively short time by compounding a cross-linking catalyst together with a cross-linking agent to the adhesive. In the optical laminate containing the optical laminated film, floating and peeling between an optical film and an adhesive layer, and foaming in the adhesive layer tend to lower, further, a re-working property tends to be improved, preferably.

Examples of the cross-linking catalyst include amine-based compound such as hexamethylenediamine, ethylenediamine, polyethyleneimine, hexamethylenetetramine, diethylenetriamine, triethylenetetramine, isophoronediamine, triethylenediamine, polyamino resin, melamine resin, and the like. When using the amine-based compound as the cross-linking catalyst in the adhesive, the isocyanate-based compound is preferably used as the cross-linking agent.

The optical laminated film of the present invention is obtained by laminating an adhesive layer composed of the above-mentioned adhesive on an optical film.

As the method for producing an optical laminated film, there are listed, for example, a method in which an adhesive diluted with an organic solvent is applied on a release film and usually heated at 60-120° C. for approximately 0.5-10 minutes to distill off the organic solvent to obtain the adhesive layer. Subsequently, an optical film is further laminated on the resulted adhesive layer, then, aged under a temperature of 23° C. and a humidity of 65% for approximately 5-20 days, after a cross-linking agent is fully reacted, the release film is peeled to obtain an optical laminated film;

a method in which the adhesive layer is obtained as the same manner in the above-mentioned method, then, two layer laminate composed of the resulted adhesive layer and a release film is combined so that the adhesive layer and the release film are layered alternatively to obtain a multi-layer laminate, then, aged under a temperature of 23° C. and a humidity of 65% for approximately 5-20 days, after a cross-linking agent is fully reacted, the release film is peeled, and an optical film instead of the release film is laminated to obtain an optical laminated film; and the like.

Here, the release film is the base material in forming the adhesive layer. When aging and preserving as the optical laminated film, the release film is used as the base material for protecting the adhesive layer from dust and the like.

As the release film, there are mentioned, for example, those obtained by using as a base material a film composed of various resins such as polyethylene terephthalate, polybutylene terephthalate, polycarbonate, polyallylate and the like, and performing releasing treatment (silicone treatment and the like) on a surface to be connected to an adhesive layer of this base material.

Here, the optical film is a film having an optical property, and examples thereof include a polarizing film, phase retardation film and the like.

The polarizing film is an optical film having a function of emitting polarization against incidence light such as natural light and the like.

Examples of the polarizing film include a straight line polarizing film absorbing straight line polarization on a vibration place parallel to an optical axis and allowing permeation of straight light polarization having a vibration plane which is a vertical plane; a polarizing separation film reflecting straight line polarization on a vibration plane parallel to an optical axis; an elliptic polarizing film obtained by laminating a polarizing film and a phase retardation film described later.

As the specific examples of the polarizing film, those in which dichroic coloring matters such as iodine, dichroic dyes and the like are adsorbed and oriented in an mono-axially stretched polyvinyl alcohol film mono-axially stretched, and the like are listed.

The phase retardation film is an optical film having mono-axial or bi-axial optical anisotropy, and listed are stretched films obtained by stretching at approximately 1.01 to 6-fold a polymer film composed of polyvinyl alcohol, polycarbonate, polyester, polyallylate, polyimide, polyolefin, polystyrene, polysulfone, polyether sulfone, polyvinylidene fluoride/polymethyl methacryalte, liquid crystal polyester, acetylcellulose, cyclic polyolefin, ethylene-vinyl acetate copolymer saponified material, polyvinyl chloride and the like. Among them, polymer films obtained by mono-axial or bi-axial stretching of polycarbonate or polyvinyl alcohol are preferably used.

Examples of the phase retardation film include a mono-axial phase retardation film, wide viewing angle phase retardation film, low photo-elastic phase retardation film, temperature-compensated phase retardation film, LC film (rod-like liquid crystal twisted orientation), WV film (disc-like liquid crystal inclined orientation), NH film (rod-like liquid crystal inclined orientation), VAC film (complete bi-axial orientation type phase retardation film), new VAC film (bi-axial orientation type phase retardation film) and the like.

On both surfaces or one surface of the above-mentioned optical film, a protective film may be further applied. Examples of the protective film include films composed of acrylic resins different from the acrylic resin of the present invention, acetylcellulose-based films such as a cellulose triacetate film and the like, polyester resin films, olefin resin films, polycarbonate resin films, polyether ketone resin films, polysulfone resin films and the like.

In the protective film, ultraviolet absorbers such as a salicylate-based compound, benzophenone-based compound, benzotriazole-based compound, triazine-based compound, cyanoacrylate-based compound, nickel complex salt-based compound and the like may be compounded. In the protective films, acetylcellulosed-based films are suitably used.

The optical laminate of the present invention is usually obtained by laminating a glass base plate on an adhesive layer of an optical laminated film.

Here, examples of the glass bass plate include a glass base plate of liquid crystal cell, non-glaring glass, glass for sunglasses, and the like. Among them, an optical laminate obtained by laminating an optical laminated film (upper plate polarization plate) on a upper glass base plate of a liquid crystal cell, and laminating another optical laminated film (lower plate polarization plate) on a lower glass base plate of a liquid crystal cell is preferable since it can be used as a liquid crystal display. As the material of a glass base plate, for example, soda lime glass, low-alkali glass, non-alkali glass and the like are listed.

The optical laminate of the present invention can be suppressed floating and peeling of the adhesive layer from the glass base plate and foaming in the adhesive layer.

In the optical laminate of the present invention, there occurs no change of outer appearances such as light leakage, floating and peeling, foaming, fogging and the like when repeating heating and cooling, therefore the optical laminate is excellent in durability.

Even after peeling of an optical laminated film from the optical laminate of the present invention, fogging and paste remaining and the like scarcely occur on the surface of a glass base material in contact with an adhesive layer, consequently, it is easy to apply an optical laminated film again on the peeled glass base plate, therefore, a so-called re-working property is excellent.

The adhesive obtained by using the acrylic resin composition of the present invention can be used, for example, as an adhesive suitable for an optical laminate such as TN liquid crystal cell and the like.

When using the adhesive obtained by using the acrylic resin composition of the present invention for STN liquid crystal cell, non-uniformity color of the obtained optical laminate can be suppressed.

### EXAMPLES

The present invention will be described further in detail based on examples, but it is needless to say that the scope of the invention is not limited to these examples at all.

In the examples, parts and % are by weight unless otherwise stated.

The content of non-volatile components was measured according to JIS K-5407. Specifically, an optional weight of adhesive solution was placed on a Petri dish, and dried in an explosion protection oven at 115° C. for 2 hours, then, the weight of remaining non-volatile components was divided by the weight of the originally weighed solution.

The viscosity is a value measured by a Brook field viscometer at 25° C.

Measurement of the weight-average molecular weight by GPC light scattering method was conducted using a GPC apparatus equipped with a light scattering photometer and a differential refractometer as a detector, under conditions of a sample concentration of 5 mg/ml, a sample introduction amount of 100 μl, a column temperature of 40° C. and a flow rate of 1 ml/min. and using tetrahydrofuran as an eluent.

Measurement of the weight-average molecular weight based on polystyrene calibration standard was conducted by measuring samples and standard polystyrene under the same GPC conditions and converting the molecular weight by using retention time.

<Production Example of Acrylic Resin>

### Polymerization Example 1

Into a reactor equipped with a cooling tube, nitrogen introduction tube, thermometer and stirrer was charged a mixed solution of 100 parts of ethyl acetate, 98.9 parts of butyl acrylate and 1.1 parts of acrylic acid, air in the apparatus was purged with a nitrogen gas to make no-oxygen atmosphere, then, the inner temperature was raised to 70° C. 0.03 parts of azobisisobutyronitrile (hereinafter, referred to as AIBN) was dissolved in 10 parts of ethyl acetate and the prepared solution was all added to the reactor. Thereafter, the reaction was completed while the inner temperature is keeping at 69 to 71° C. for 12 hours. The weight-average molecular weight based on polystyrene calibration standard by GPC was 1,200,000.

<Acrylic Resin Composition and Production Example of Adhesive Containing the Same Composition>

### Example 1

To 100 parts of the acrylic resin solution obtained in Polymerization Example 1 was mixed 0.05 part of a polyisocyanate-based compound (trade name: Takenate D-160N, manufactured by Mitsui-Takeda Chemical Inc.) as a cross-linking agent and 0.02 part of a silane-based compound (trade name: IM-1000, manufactured by Nikko Materials Co., Ltd.), to obtain an adhesive of the present invention.
<Analysis of a Silane-Based Compound (Trade Name: Im-1000, Manufactured by Nikko Materials Co. Ltd.)>

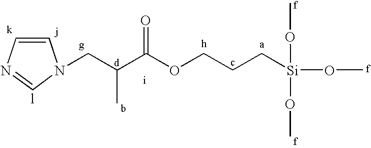

Molecular weight: 316.43, Chemical formula: C₁₃H₂₄O₅Si Mass number: [M+H]+=317.4

¹H NMR δ 0.62 (a: 2H), 1.19 (b: 3H), 1.71 (C: 2H), 2.88 (d: 1H), 3.60 (f: 9H), 4.00, 4.10 (g. h: 4H), 6.90 (j: 1H), 7.03 (k: 1H), 7.46 (1: 1H).

¹³C NMR δ 5.3 (a), 14.6 (b), 22.0 (c), 41.5 (d), 49.2 (g, i), 4.00 (f), 66.97 (h), 119.2 (j), 129.6 (k), 137.6 (1) 173.7 (i).

<Production Examples of Optical Laminated Film, and Optical Laminate>

Thus obtained adhesive was applied, using an applicator, on a releasing-treated surface of a polyethylene terephthalate film (manufactured by LINTEC Corporation, trade name: PET 3811) which had been subjected to releasing treatment so that the thickness after drying was 25 μm, the dried at 90° C. for 1 minute, to obtain an adhesive in the form of sheet. Then, a polarizing film (film having a three-layer structure obtained by adsorbing iodine into polyvinyl alcohol and stretching to obtain a stretched film and sandwiching said stretched film on both surfaces thereof by triacetylcellulose-based protective films) was used as an optical film, and a surface having the adhesive obtained above was applied on this optical film by a laminator, then, aged under a temperature of 23° C. and a humidity of 65% for 10 days, to obtain an optical laminated film having an adhesive layer. Subsequently, this optical laminated film was adhered on both surfaces of a glass base plate for liquid crystal cell (manufactured by Corning, 1737) so as to give Cross Nicol condition. This was preserved under 80° C. and dry condition for 96 hours (condition 1), 60° C. and 90% RH for 96 hours (condition 2), 100 cycles of 60° C.→−20° C.→60° C. as one cycle (condition 3), and durability (condition 1-3) and light leakage (condition 1) of the optical laminate after preservation were observed visually. The results are classified as described below and shown in Table 1.

<Light Leakage Property of Optical Laminate>

Evaluation of state of generation of light leakage was conducted according to the following four stages.
⊚: no light leakage
◯: little light leakage
Δ: slight light leakage
X; remarkable light leakage
   <Durability of Optical Laminate>

Evaluation of durability was conducted according to the following four stages.
⊚: no change in appearance such as floating, peeling, foaming and the like
◯: little change in appearance such as floating, peeling, foaming and the like
Δ: slight change in appearance such as floating, peeling, foaming and the like
X: remarkable change in appearance such as floating, peeling, foaming and the like
   <Re-Working Property>

Evaluation of the re-working property was conducted as described below. First, the above-mentioned optical laminate was processed into a specimen of 25 mm×150 mm. Then, this specimen was pasted on a glass base plate for liquid crystal cell (manufactured by Nippon Sheet Glass Co. Ltd., soda lime glass) using a pasting apparatus (“Lamipacker”, manufactured by Fuji Plastic Machine K.K.), and treated in an autoclave under 50° C., 5 kg/cm² (490.3 kPa) for 20 minutes, subsequently, heated in an oven under 70° C. for 2 hours, preserved in an oven under 70° C. for 24 hours. The optical laminate for peeling test was peeled toward 180° direction at a rate of 300 mm/min in an atmosphere of 23° C. and 65% RH, and the state of the surface of the glass plate classified according to the following conditions was observed and shown in Table 1.

Evaluation of the re-working property was conducted by observing the state of the surface of the glass plate according to the following four stages.
⊚: no fogging and past remaining on the surface of glass plate
◯: little fogging and the like on the surface of glass plate
Δ: fogging and the like on the surface of glass plate
X: paste remaining on the surface of glass plate

### Comparative Examples 1 to 3

An adhesive, optical laminated film and optical laminate were produced according to Example 1. Evaluation of the resulted optical laminate was conducted in the sane manner as in Example 1, and the results are shown In Table 1 together with that of Example 1.

TABLE 1

| | | Ex- | | | |
|---|---|---|---|---|---|
| | | ample | Comparative Example | | |
| | | 1 | 1 | 2 | 3 |
| Polymerization example | | 1 | 1 | 1 | 1 |
| Cross- | kind | D- | D- | D- | D- |
| linking | | 160N | 160N | 160N | 160N |
| agent | part by weight | 0.05 | 0.05 | 0.05 | 0.07 |
| Silane | kind | IM1000 | TSL8172 | XR31- | KBM803 |
| com- | | | | B1410 | |
| pound | part by weight | 0.02 | 0.05 | 0.05 | 0.4 |
| Condi- | Durability | ⊚ | ⊚ | ⊚ | ◯ |
| tion 1 | Light leakage | ◯ | ◯ | ◯ | ◯ |
| | property | | | | |
| Condi- | Durability | ⊚ | ◯ | ⊚ | ◯ |
| tion 2 | | | | | |
| Condi- | Durability | ◯ | X | X | X |
| tion 3 | | | | | |
| Re- | Paste remaining | ⊚ | ◯ | ◯ | ◯ |
| working | property | | | | |
| property | | | | | |

What is claimed is:

1. An acrylic resin composition comprising an acrylic resin and a silane-based compound having an azole group and having at least one group selected from the group consisting of a phenoxy group and an alkoxy group.

2. The composition according to claim 1, wherein the silane-based compound is a compound of the formula (3), a compound of the formula (4), a compound of the formula (6), or a compound of the formula (7): 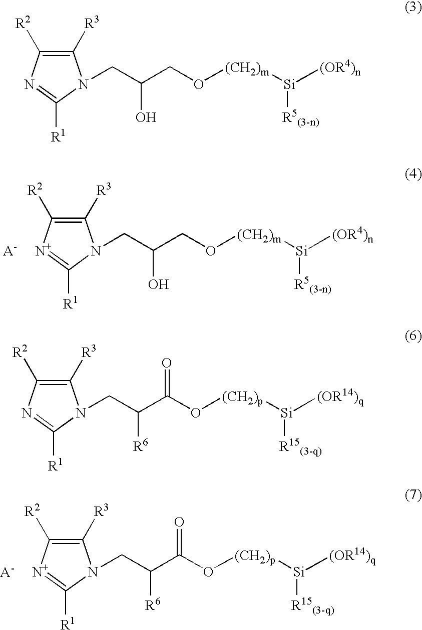
(wherein, R¹ to R³ represent each independently a hydrogen atom or a hydrocarbon group having 1 to 20 carbon atoms wherein the hydrocarbon group may contain a double bond, and R² and R³ may be connected, R⁴, R⁵, R⁶, R¹⁴ and R¹⁵ represent each independently a hydrogen atom, an aliphatic hydrocarbon group having 1 to 12 carbon atoms or an aromatic hydrocarbon group having 6 to 12 carbon atoms, m represents 1 to 10, n represents 1 to 3, p represents the same meanings as m, q represents the same meanings as n, and A⁻ represents an organic monocarboxylic acid residue).

3. The composition according to claim 1, wherein the silane-based compound is a compound selected from the group consisting of a compound of the formula (3-1), a compound of the formula (4-1), a compound of the formula (6-1) and a compound of the formula (7-1): 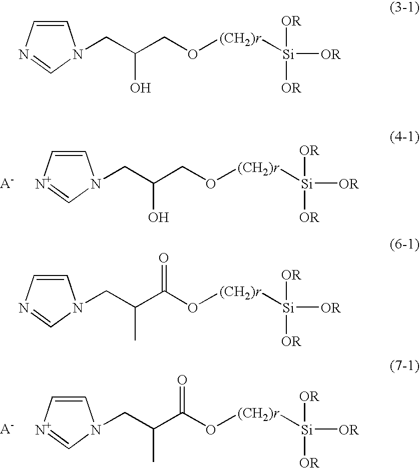
(wherein, R represents a methyl group or ethyl group, r represents 2 or 3, and A⁻ have the same meanings as defined above).

4. The composition according to claim 1, wherein the acrylic resin is an acrylic resin having a structural unit derived from an alkyl (meth)acrylate as a main component, and containing a structural unit derived from (meth)acrylic acids containing at least one polar functional group selected from the group consisting of a hydroxyl group, amino group, free carboxyl group and heterocyclic group.

5. An adhesive obtained by compounding the composition according to claim 1 and a cross-linking agent.

6. An optical laminated film laminating an adhesive layer composed of the adhesive according to claim 5 on both surfaces or one surface of an optical film.

7. The optical laminated film according to claim 6, wherein the optical film is a polarizing film and/or phase retardation film.

8. The optical laminated film according to claim 6, wherein the optical film further has an acetylcellulose-based film as a release film.

9. The optical laminated film according to claim 6, wherein a release film is further laminated on the adhesive layer of the optical laminated film.

10. An optical laminate obtained by laminating a glass base material on the adhesive layer of the optical laminated film according to claim 6.

11. An optical laminate obtained by peeling the release film from the optical laminated film according to claim 9, then, laminating a glass base material on the adhesive layer of the optical laminated film.

12. An optical laminate obtained by peeling the optical laminated film from the optical laminate according to claim 10, then, laminating again the optical laminated film on the resulted glass base material.
